(19) United States
(12) Patent Application Publication
(10) Pub. No.: US 2014/0004850 A1
(43) Pub. Date: Jan. 2, 2014

(54) APPARATUS AND METHOD FOR CONTROLLING PAGING IN HETEROGENEOUS WIRELESS NETWORK SYSTEM

(71) Applicants: Ki Bum Kwon, Seoul (KR); Jae Hyun Ahn, Seoul (KR)

(72) Inventors: Ki Bum Kwon, Seoul (KR); Jae Hyun Ahn, Seoul (KR)

(73) Assignee: PANTECH CO., LTD., Seoul (KR)

(21) Appl. No.: 14/005,434

(22) PCT Filed: Mar. 29, 2012
(86) PCT No.: PCT/KR2012/002336

§ 371 Date: Sep. 16, 2013

(30) Foreign Application Priority Data
Mar. 31, 2011 (KR) 10-2011-0029640

(51) Int. Cl. H04W 68/02; H04W 24/02

(52) U.S. Cl. CPC H04W 68/02; H04W 24/02
USPC 455/423; 455/458

(57) ABSTRACT

The present invention relates to an apparatus and a method for controlling paging in a heterogeneous wireless network system. The present invention discloses a base station comprising: an adjacent base station recognition unit for recognizing an aggressor cell; a paging control unit for changing a paging parameter, deciding a paging frame or a paging opportunity based on the changed paging parameter, and for generating a paging message; and a signal transmission unit for transmitting to the user equipment system information including the changed paging parameter, and transmitting to the user equipment the paging message on the paging frame or the paging opportunity. According to the present invention, in the heterogeneous wireless network system in which a variety of cells, such as macrocells, microcells, picocells, and femtocells, among others, coexist, a terminal in an RRC resting state not having a femtocell membership can facilitate paging reception of the macrocell.

### CROSS-REFERENCE TO RELATED APPLICATIONS

This application is the National Stage Entry of International Application PCT/KR2012/002336, filed on Mar. 29, 2012, and claims priority from and the benefit of Korean Patent Application No. 10-2011-0029640, filed on Mar. 31, 2011, both of which are incorporated herein by reference in their entireties for all purposes as if fully set forth herein.

### BACKGROUND

1. Field

The present invention relates to wireless communication and, more particularly, to an apparatus and method for controlling paging in a heterogeneous wireless network system.

2. Discussion of the Background

3^{rd} Generation Partnership Project (3GPP) Long Term Evolution (LTE), that is, the improvement of a Universal Mobile Telecommunications System (UMTS), is introduced as 3GPP release 8. 3GPP LTE uses Orthogonal Frequency Division Multiple Access (OFDMA) in downlink and uses Single Carrier-Frequency Division Multiple Access (SC-FDMA) in uplink. 3GPP LTE adopts Multiple Input Multiple Output (MIMO) having a maximum of 4 antennas. 3GPP LTE-Advanced (LTE-A), that is, the evolution of 3GPP LTE, is recently being discussed.

With the development of wireless communication technology, a heterogeneous network environment comes to the front.

A macro cell, a femto cell, a pico cell, etc. are used in this heterogeneous network environment. As compared with a macro cell, a femto cell or a pico cell is a system that covers an area smaller than the existing mobile communication service radius.

In this communication system, a user terminal present in any one of a macro cell, a femto cell, and a pico cell is subject to inter-cell interference that is caused by signal interference due to a signal generated from another cell. In particular, if a terminal communicating with a macro cell enters the interference area of a femto cell, there is a problem in that the terminal cannot properly obtain a paging message from the macro cell.

### SUMMARY

An object of the present invention is to provide an apparatus and method for controlling paging in a heterogeneous wireless network system.

Another object of the present invention is to provide an apparatus and method for coordinating interference between heterogeneous cells by changing a paging parameter.

Yet another object of the present invention is to provide an apparatus and method for triggering a change of a paging parameter.

Further yet another object of the present invention is to provide an apparatus and method for changing a paging parameter using an ANR procedure.

Still yet another object of the present invention is to provide an apparatus and method for changing a paging parameter using an ABS pattern.

In accordance with an aspect of the present invention, there is provided an eNB for controlling paging in a wireless network system supporting heterogeneous cells. The eNB includes an adjacent eNB detection unit for detecting an aggressor cell that generates interference between the heterogeneous cells, a paging control unit for changing a paging parameter when detecting the aggressor cell, configuring a paging occasion indicative of a subframe on which a paging message is transmitted or a paging frame that is a radio frame including the or at least one paging occasion based on the changed paging parameter, and generating a paging message for paging UE, and a signal transmission unit for sending system information including the changed paging parameter to the UE and sending the paging message to the UE in the paging frame or the paging occasion.

In accordance with another aspect of the present invention, there is provided a method of an eNB controlling paging in a wireless network system supporting heterogeneous cells. The method includes detecting an aggressor cell that generates interference between the heterogeneous cells, changing the paging parameter when detecting the aggressor cell, configuring a paging occasion indicative of a subframe on which a paging message is transmitted or a paging frame that is a radio frame including the or at least one paging occasion based on the changed paging parameter, sending system information including the changed paging parameter to UE, and sending a paging message for paging the UE to the UE in the paging frame or the paging occasion.

In accordance with the present invention, in a heterogeneous wireless network system in which various types of cells, such as a macro cell, a micro cell, a pico cell, and a femto cell, coexist, UE in an RRC idle state, not having memberships to a femto cell, can easily receive the paging of a macro cell when a TDM method is used to control interference generated between heterogeneous cells.

### BRIEF DESCRIPTION OF THE DRAWINGS

FIG. 1 shows a wireless communication system to which the present invention is applied;

FIG. 2 is an exemplary diagram showing a cell selection process performed by UE in an RRC idle state according to the present invention;

FIG. 3 schematically illustrates the concept of a heterogeneous network that includes a macro eNB, a femto eNB, and a pico eNB according to the present invention;

FIG. 4 schematically illustrates that UE is influenced by interference between a macro cell, a femto cell, and a pico cell in downlink;

FIG. 5 is a diagram showing a frame pattern for ICIC in a heterogeneous network system in accordance with an example of the present invention;

FIG. 6 is a flowchart illustrating a method of controlling paging in accordance with an example of the present invention;

FIG. 7 is a flowchart illustrating a method of a macro eNB detecting a femto eNB in order to control paging in accordance with an example of the present invention;

FIG. 8 is a flowchart illustrating a method of a macro eNB detecting a femto eNB in order to control paging in accordance with another example of the present invention;

FIG. 9 is an explanatory diagram illustrating an ANR procedure in accordance with an example of the present invention;

FIG. 10 is a flowchart illustrating a method of a macro eNB controlling paging in accordance with an example of the present invention; and

FIG. 11 is a block diagram of a macro eNB, UE, and an OAM in accordance with an example of the present invention.

### DETAILED DESCRIPTION OF THE ILLUSTRATED EMBODIMENTS

Hereinafter, in this specification, some exemplary embodiments of the present invention will be described in detail with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in this specification, a wireless communication network is described as a target, and tasks performed over the wireless communication network can be performed in a process in which a system (e.g., a base station) managing the wireless communication network controls the wireless communication network and sends data or can be performed by a terminal that accesses the wireless communication network.

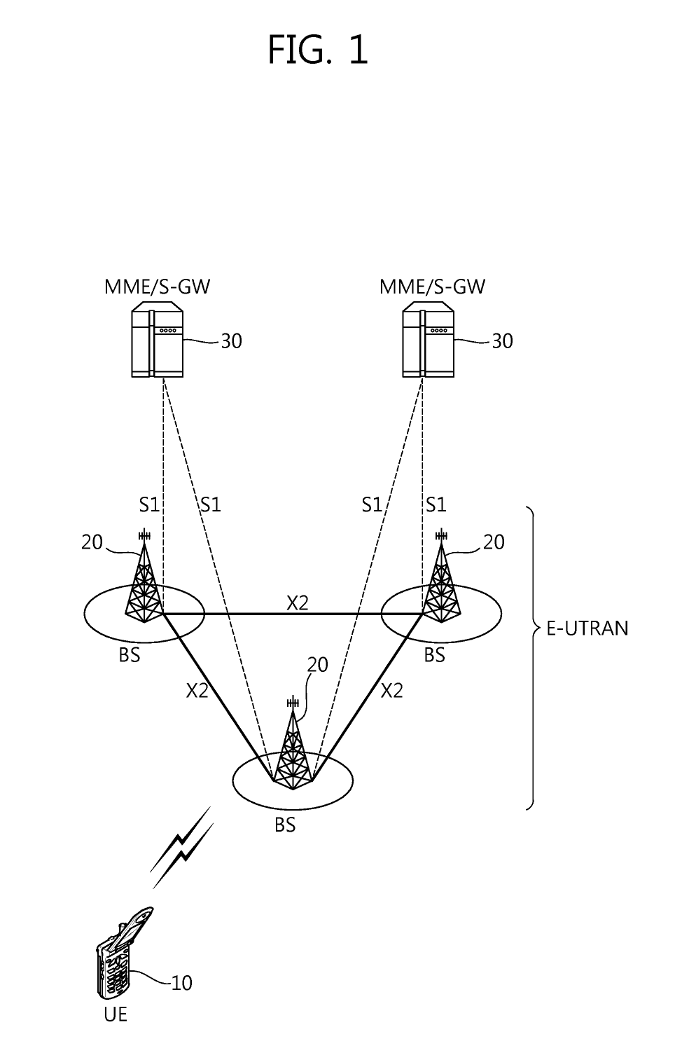

FIG. 1 shows a wireless communication system to which the present invention is applied. The wireless communication system may also be called an Evolved-UMTS Terrestrial Radio Access Network (E-UTRAN) system, a Long Term Evolution (LTE) system, or an LTE-Advanced (LTE-A) system.

Referring to FIG. 1, an Evolved-UMTS Terrestrial Radio Access Network (E-UTRAN) includes a Base Station (BS) 20 providing a control plane and a user plane to User Equipment (UE) 10. The UE 10 can be fixed or mobile and also called another terminology, such as a Mobile Station (MS), a User Terminal (UT), a Subscriber Station (SS), a Mobile Terminal (MT), or a wireless device. The BS 20 refers to a fixed station that communicates with the UE 10. The BS 20 can also be called another terminology, such as an evolved-NodeB (eNB), a Base Transceiver System (BTS), an access point, a home eNB (HeNB), a relay, or a Remote Radio Head (RRH).

The BSs 20 can be coupled through an X2 interface. The BS 20 is coupled to an Evolved Packet Core (EPC) 30 through an S1 interface, more particularly, to a Mobility Management Entity (MME) through an S1-MME and to a Serving Gateway (S-GW) through an S1-U. The S1 interface exchanges pieces of Operation and Management (OAM) information for supporting the mobility of the UE 10 by exchanging signals with the MME.

The EPC 30 includes the MME, the S-GW, and a Packet Data Network-Gateway (P-GW). The MME has information about the access of the UE 10 or information about the capabilities of the UE 10. The information is chiefly used to manage the mobility of the UE 10. The S-GW is a gateway that has an E-UTRAN as a termination point, and the P-GW is a gateway that has a PDN as a termination point.

The layers of a radio interface protocol between the UE 10 and a network can be classified into a first layer L1, a second layer L2, and a third layer L3 on the basis of three lower layers of an Open System Interconnection (OSI) reference model which is widely known in communication systems. From among them, a physical layer belonging to the first layer provides information transfer service using a physical channel, and a Radio Resource Control (RRC) layer placed in the third layer functions to control radio resources between the UE 10 and a network. To this end, RRC messages are exchanged between the UE 10 and the network in the RRC layer.

A physical (PHY) layer provides information transfer service to a higher layer using a physical channel. The physical layer is connected to a Medium Access Control (MAC) layer that belongs to the second layer through a transport channel. Data is moved between the MAC layer and the physical layer through the transport channel. The transport channel is classified depending on how data is moved according to what characteristic through a radio interface.

Data is moved between different physical layers, that is, the physical layers of a transmitter and a receiver through a physical channel. The physical channel is modulated according to an Orthogonal Frequency Division Multiplexing (OFDM) scheme. The physical channel uses time and a frequency as radio resources.

The functions of the MAC layer include mapping between a logical channel and the transport channel and multiplexing and demultiplexing to a transport block provided to a physical channel on the transport channel of a MAC Service Data Unit (SDU) that belongs to a logical channel. The MAC layer provides service to a Radio Link Control (RLC) layer through a logical channel.

The functions of the RLC layer belonging to the second layer include the concatenation, segmentation, and reassembly of an RLC SDU. In order to guarantee various types of Quality of Service (QoS) necessary for a Radio Bearer (RB), the RLC layer provides three operation modes: Transparent Mode (TM), Unacknowledged Mode (UM), and Acknowledged Mode (AM). AM RLC provides error correction through an Automatic Repeat Request (ARQ).

The functions of a Packet Data Convergence Protocol (PDCP) layer in the user plane include the transfer of user data and the compression and ciphering of a header. The functions of the PDCP layer in the user plane further includes the transfer of control plane data and encryption/integrity protection.

The RRC layer belonging to the third layer is defined only in the control plane. The RRC layer is related to the configuration, reconfiguration, and release of radio bearer and is responsible for control of logical channels, transport channels, and physical channels. A Radio Bearer (RB) means a logical route that is provided by the first layer (i.e., PHY layer) and the second layer (i.e., MAC layer, RLC layer, and PDCP layer) in order to transfer data between the UE 10 and a network. To configure an RB means a process of defining the characteristics of a radio protocol layer and channels in order to provide specific service and configuring each detailed parameter and operating method. An RB can be divided into a Signaling RB (SRB) and a Data RB (DRB). The SRB is used as a passage through which an RRC message is transmitted in the control plane, and the DRB is used as a passage through which user data is transmitted in the user plane.

If RRC connection is present between the RRC layer of the UE 10 and the RRC layer of an E-UTRAN, the UE 10 is in an RRC-connected state. If not, the UE 10 is in an RRC idle state.

A downlink transport channel through which data is transmitted from a network to the UE 10 includes a broadcast channel (BCH) through which system information is transmitted and a downlink shared channel (SCH) through which user traffic or a control message is transmitted. Traffic or a control message for downlink multicast or broadcast service may be transmitted through a downlink SCH or may be transmitted through an additional downlink multicast channel (MCH). Meanwhile, an uplink transport channel through which data is transmitted from the UE 10 to a network includes a random access channel (RACH) through which an initial control message is transmitted and an uplink shared channel (SCH) through which user traffic or a control message is transmitted.

Logical channels placed over a transport channel and mapped to a transport channel include a broadcast control channel (BCCH), a paging control channel (PCCH), a common control channel (CCCH), a multicast control channel (MCCH), and a multicast traffic channel (MTCH).

A physical channel includes several symbols in a time domain and several subcarriers in a frequency domain. One subframe includes a plurality of symbols in the time domain. One subframe includes a plurality of resource blocks, and one resource block includes a plurality of symbols and a plurality of subcarriers. Furthermore, each subframe can use specific subcarriers of specific symbols (e.g., first symbol) of the subframe for a physical control channel called a physical downlink control channel (PDCCH). A Transmission Time Interval (TTI), that is, a unit time that is taken for data to be transmitted, is 1 ms corresponding to one subframe.

An RRC state of UE and an RRC connection method are described below.

An RRC state means whether or not the RRC layer of UE is logically connected to the RRC layer of an E-UTRAN. A case where the RRC layer of UE is logically connected to the RRC layer of an E-UTRAN is called an RRC-connected state. A case where the RRC layer of UE is not logically connected to the RRC layer of an E-UTRAN is called an RRC idle state. An E-UTRAN can check the existence of UE in an RRC-connected state in a cell unit because RRC connection is present in the UE, and thus the UE can be effectively controlled. In contrast, UE in an RRC idle state is not checked by an E-UTRAN and is managed by a core network in a tracking area unit, that is, an area unit larger than a cell. That is, the existence or non-existence of UE in an RRC idle state is checked only in a large area unit. Thus, UE needs to shift to an RRC-connected state in order to receive common mobile communication service, such as voice or data.

When a user first turns on the power of UE, the UE attempts to establish access to a Public Land Mobile Network (PLMN). A specific PLMN accessed by UE can be selected automatically or manually. Here, the PLMN means a wireless communication system to be used by a user who is placed within a vehicle or who is walking on the ground. Alternatively, the PLMN may indicate all mobile radio networks that use an eNB based on the ground in addition to satellites. A Home PLMN (HPLMN) is a PLMN having the same Mobile Network Code (MNC) as a Mobile Country Code (MCC) that is included in an International Mobile Subscriber Identity (IMSI), that is, a unique 15-digit code that is used to check an individual user in a Global System for Mobile (GSM) communication network. An Equivalent HPLMN (EHPLMN) list refers to a list of PLMN codes that replace HPLMN codes extracted from the IMSI in order to permit the providing of multiple HPLMN codes. The EHPLMN list is stored in a Universal Subscriber Identity Module (USIM). The EHPLMN list may include HPLMN codes extracted from the IMSI. If an HPLMN code extracted from the IMSI is not included in an EHPLMN list, an HPLMN should be treated as a visited PLMN when selecting a PLMN. A visited PLMN is a PLMN that is different from an HPLMN and an EHPLMN (if it is present). A Registered PLMN (RPLMN) is a PLMN in which what Location Registration (LR) results are generated. In general, in a shared network, an RPLMN is a PLMN that is defined by checking the PLMN of a core network operator that has permitted LR.

UE searches a selected PLMN for a suitable cell and then remains in an RRC idle state in the suitable cell. The UE in an RRC idle state selects a cell capable of providing possible services, and the UE is controlled according to a control channel of the selected cell. This process is called “camp on a cell”. When the camp-on is completed, the UE can register its existence with the registration area of the selected cell. This is called LR. The UE regularly registers its existence with the registration area or registers its existence with the registration area when it enters a new Tracking Area (TA). The registration area refers to a specific area that can be roamed by the UE without an LR process.

If UE gets out of the service area of a cell or has founded a more suitable cell, the UE reselects the most suitable cell within a PLMN and camps on the reselected cell. If a new cell is included in another registration area, an LR request is performed. If the UE gets out of the service area of the PLMN, a new PLMN can be automatically selected or a new PLMN can be manually selected by a user.

An object of camp-on performed by UE in an RRC idle state is as follows.

1) UE receives system information from a PLMN

2) UE first accesses a network through the control channel of a camped-on cell after a cell is initialized

3) UE receives a paging message: If a PLMN receives a call for UE, the PLMN is aware of the registration area of a cell that has been camped on by the UE. Accordingly, the PLMN can send a paging message for the UE through the control channels of all cells within the registration area. The UE can receive the paging message because the UE has already been controlled according to the control channel of the camped-on cell.

4) UE receives a broadcasting message from a cell

If UE is unable to search for a suitable cell to be camped on, a Subscriber Identity Module (SIM) has not been inserted into the UE, or a specific response to an LR request has been received (e.g., ‘illegal UE’), the UE attempts camp-on irrespective of a PLMN and enters a ‘limited service’ state. The limited service state is a state in which only an emergency call is possible.

When it is necessary to establish RRC connection, UE in an RRC idle state establishes RRC connection to an E-UTRAN through an RRC connection process and shifts to an RRC-connected state. A case where UE in an RRC idle state needs to establish RRC connection includes several cases. For example, the several cases can include a case where uplink data needs to be transmitted for a reason, such as a user's attempt to make a cell, or a case where a response message is transmitted in response to a paging message received from an E-UTRAN.

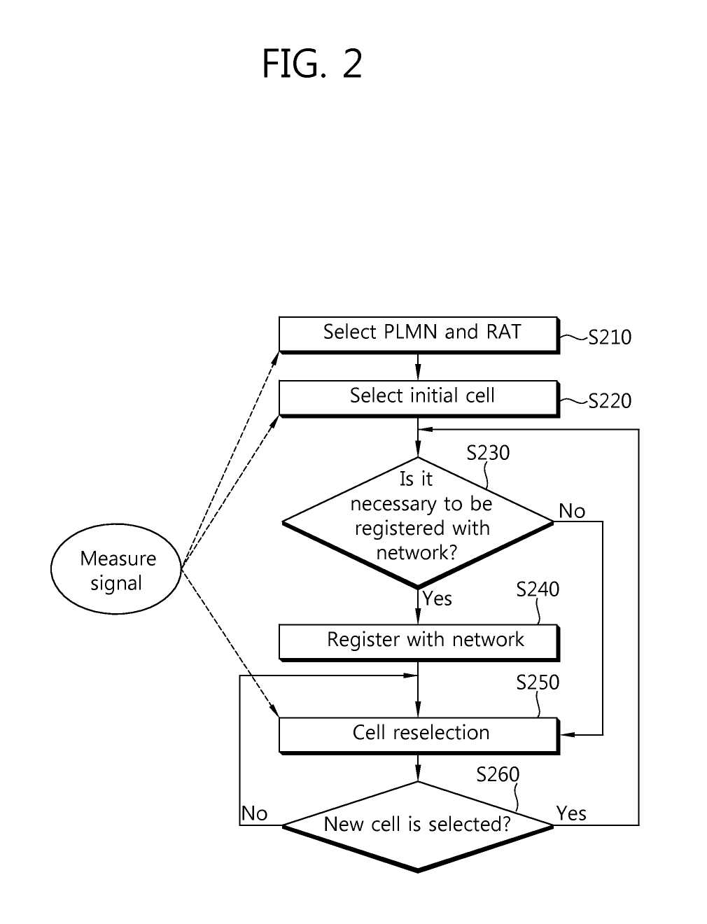

FIG. 2 is an exemplary diagram showing a cell selection process performed by UE in an RRC idle state according to the present invention.

Referring to FIG. 2, the UE selects a PLMN from which service will be received and Radio Access Technology (RAT) at step S210. The user of the UE may select the PLMN and the RAT, or a PLMN and RAT stored in the USIM of the UE may be used.

The UE selects a measured eNB and a cell having the greatest value, from cells having the intensity or quality of a signal higher than a specific value at step S220. Next, the UE receives system information that is periodically transmitted by the eNB. The specific value refers to a value defined in a system in order to guarantee quality for a physical signal in data transmission and reception. Accordingly, the specific value may be different depending on applied RAT.

The UE determines whether or not network registration is necessary at step S230. If, as a result of the determination, it is determined that network registration is necessary, the UE registers its own information (e.g., IMSI) with the network in order to receive service (e.g., paging) from the network at step S240. The UE does not need to be registered with a network that is accessed whenever it selects a cell. For example, if system information (e.g., Tracking Area Identity (TAI)) about a network to be registered with is different from information about the network that is known to the UE, the UE registers its own information with the network.

If the intensity or quality of a signal measured by an eNB that provides service to the UE is lower than that of a signal measured by an eNB of a neighbor cell, the UE selects a cell that provides better signal characteristics than those provided by the cell of an eNB that the UE has accessed at step S250. This process is distinguished from the initial cell selection at step S220 and is called cell reselection. Here, a time limit condition may be imposed in order to prevent a cell from being frequently reselected in response to a change of a signal characteristic.

A process of UE selecting a cell is described in detail below.

When UE is power on or the UE remains in a cell, the UE performs processes for selecting or reselecting a cell having suitable quality and receiving service.

UE in an RRC idle state needs to be always prepared to select a cell having suitable quality and receive service through the selected cell. For example, UE that is just powered on needs to select a cell having suitable quality in order to register its own information with a network. When UE in an RRC-connected state enters an RRC idle state, the UE has to select a cell in which the UE will remain in an RRC idle state. As described above, a process in which UE selects a cell that satisfies a specific condition in order to remain in a service standby state, such as an RRC idle state, is called cell selection. In cell selection, it is important to select a cell as rapidly as possible because UE performs the cell selection in the state in which the UE has not determined a cell in which the UE will remain in an RRC idle state. Accordingly, if a cell that provides a radio signal having quality of a specific level or higher is not a cell that provides the best radio signal quality to UE, the cell can be selected in the cell selection process of the UE.

The cell selection process is basically divided into two types.

One of the two types is an initial cell selection process. In this process, UE is unaware of prior information about a radio channel. Accordingly, the UE searches all radio channels for a suitable cell. The UE searches each channel for the strongest cell. Next, if a suitable cell that satisfies a criterion for cell selection is retrieved, the UE selects the corresponding cell.

The other of the two types is a cell selection process using stored information. In this process, information stored in UE is used in relation to a radio channel, or cell selection is performed using information broadcasted by a cell. Accordingly, cell selection can be rapidly performed as compared with the initial cell selection process. UE selects a cell if the cell that satisfies a criterion for cell selection has only to be searched for. If a suitable cell that satisfies a criterion for cell selection is not searched for through this process, the UE performs the initial cell selection process.

The criterion for cell selection used by UE in the cell selection process is the same as Equation 1 below.

Srxlev>0 and Squal>0 [Equation 1]

In Equation 1, Srxlev=Qᵣₓₗₑᵥₘₑₐₛ−(Qᵣₓₗₑᵥₘᵢₙ+Q_{rxlevminoffset})+Pcompensation. Qᵣₓₗₑᵥₘₑₐₛ is RSRP of a measured cell, Qᵣₓₗₑᵥₘᵢₙ is a minimum necessary reception level (dBm) in a cell, Q_{rxlevminoffset} is an offset for Qᵣₓₗₑᵥₘᵢₙ, Pcompensation=max(P_{EMAX}−P_{UMAX}, 0) (dB), P_{EMAX} is maximum transmission power (dBm) that may be transmitted by UE in a corresponding cell, and P_{UMAX} is maximum transmission power (dBm) of a UE radio transmission unit (RF) according to the capabilities of UE.

From Equation 1, it can be seen that UE selects a cell having the intensity and quality of a measured signal that is greater than a specific value. The specific value can be defined in a cell that provides service. Furthermore, the parameters used in Equation 1 are broadcasted through system information, and the UE receives the parameter values and uses the values in the criterion for cell selection.

After selecting a cell that satisfies the criterion for cell selection, the UE receives information for the RRC idle state operation of the UE in the selected cell from system information transmitted by the selected cell. After receiving all pieces of information for the RRC idle state operation, the UE requests service (e.g., originating call) from a network or waits in an idle mode in order to receive service (e.g., terminating call) from the network.

After the UE selects a cell through cell selection process, the intensity or quality of a signal between the UE and an eNB may be changed due to a change of the mobility of the UE or a wireless environment. Accordingly, if the quality of the selected cell is deteriorated, the UE can select another cell that provides better quality. If a cell is reselected as described above, the UE selects a cell that provides better signal quality than that provided by a current selected cell. This process is called cell reselection. An object of the cell reselection process is to select a cell that provides the best quality to UE from a viewpoint of the quality of a radio signal.

In addition to a viewpoint of the quality of a radio signal, a network can determine priority for each frequency and informs UE of the determined priority. The UE which has received the priority takes the priority into consideration over a criterion for radio signal quality in the cell reselection process.

A heterogeneous network is described below.

It is difficult to satisfy a need for increasing data service by simply partitioning a macro cell and a micro cell. Accordingly, data service for an indoor or outdoor small area can be operated using a pico cell, a femto cell, and a radio relay. A use of a small cell is not specially restricted, but a pico cell can be commonly used in a so-called hot zone, such as a communication shadow area not covered by only a macro cell or an area that requires many data service. In general, a femto eNB can be used in an indoor office or a home. Furthermore, a radio relay can supplement the coverage of a macro cell. The shadow area of data service can be obviated or a data transfer rate can be increased by configuring a heterogeneous network.

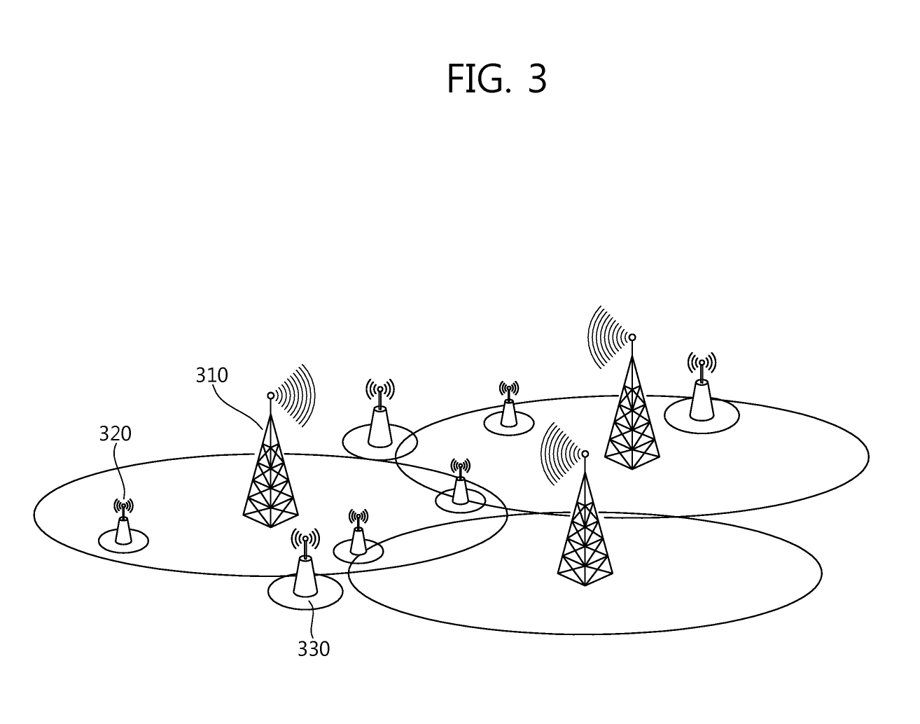

FIG. 3 schematically illustrates the concept of a heterogeneous network that includes a macro eNB, a femto eNB, and a pico eNB according to the present invention. FIG. 3 illustrates a heterogeneous network including a macro eNB, a femto eNB, and a pico eNB, for convenience of description, but the heterogeneous network may include a relay or other types of eNBs.

Referring to FIG. 3, a macro eNB 310, a femto eNB 320, and a pico eNB 330 are together operated in a heterogeneous network. The macro eNB 310, the femto eNB 320, and the pico eNB 330 provide a macro cell, a femto cell, and a pico cell, that is, respective cell coverages, to UE.

The femto eNB 320 is a low-power wireless access point and is an eNB for ultra small-sized mobile communication which is used in the interior of a room, such as a home or an office. The femto eNB 320 can access a mobile communication core network using a DSL or a cable broadband, etc. at a home or an office. A self-organization function can be supported in the femto eNB 320. The self-organization function is classified into a self-configuration function, a self-optimization function, and a self-monitoring function.

The self-configuration function is a function that enables a wireless eNB to be installed on the basis of an initial installation profile without a cell planning step. The self-configuration function has to satisfy the following requirements. First, the femto eNB 320 needs to be able to establish a security link with a Mobile Operation and Management Network (MON) according to the security policy of a network service provider. Second, an HNB Management System (HMS) and the femto eNB 320 need to be able to initialize the downloading and activation of software of the femto eNB 320. Third, the HMS needs to be able to initialize the providing of transport resources to the femto eNB 320 in order to establish a signaling link with a PLMN. Fourth, the HMS needs to provide the femto eNB 320 with radio network-specific information that enables the femto eNB 320 to be automatically set in an operable state.

The self-optimization function is a function of identifying an adjacent eNB, obtaining information from the eNB, optimizing a list of adjacent eNBs, and optimizing coverage and communication capacity in response to subscribers and a change of traffic. The self-monitoring function is a function of performing control based on gathered information so that service performance is not deteriorated.

A femto eNB can divide users into a registered user and an unregistered user and allow only the registered user to access thereto. A cell which allows only a registered user to access thereto is called a Closed Subscriber Group (hereinafter referred to as a ‘CSG’), and a cell which allows a common user to access thereto is called an Open Subscriber Group (hereinafter referred to as an ‘OSG’). Furthermore, the CSG and the OSG may be mixed and operated.

In 3GPP, an eNB that provides femto cell service is called a femto eNB, a Home NodeB (HNB), or a Home eNodeB (HeNB). An object of the femto eNB 320 is basically to provide specified service to only a member who belongs to a CSG. From a stand point in which service is provided, when the femto eNB 320 provides service to only a CSG group, a cell provided by the femto eNB 320 is called a CSG cell.

Each CSG has a unique identifier, and the identifier is called a CSG identity (ID). UE can have a list of CSGs to which the UE belongs as a member, and the list of CSGs is also called a white list. What a CSG cell supports what CSG can be checked by reading a CSG ID that is included in system information. After reading a CSG ID, UE considers a corresponding cell to be a cell to which the UE can be connected only when the UE is a member of a corresponding CSG cell, that is, when a CSG corresponding to a CSG ID is included in the UE's CSG white list.

The femto eNB 320 does not need to be always allowed to access CSG UE. Furthermore, the femto eNB 320 may be allowed to access UE that is not a CSG member depending on the configuration setting of the femto eNB 320. Whether the femto eNB 320 will be allowed to access what UE is changed depending on the configuration setting of the femto eNB 320. Here, the configuration setting means setting an operation mode for the femto eNB 320. The operation mode of the femto eNB 320 is classified into three types as below depending on that service is provided to what UE.

1) A closed access mode: a mode in which service is provided to only a specific CSG member. The femto eNB 320 provides a CSG cell.

2) An open access mode: a mode in which service is provided without a restriction, such as a specific CSG member, as in a common eNB. The femto eNB 320 provides a common cell not a CSG cell.

3) A hybrid access mode: a mode in which CSG service can be provided to a specific CSG member and service is provided to a non-CSG member as in a normal cell. The hybrid access mode is recognized by CSG member UE as a CSG cell and is recognized by non-CSG member UE as a normal cell. This cell is called a hybrid cell.

In a heterogeneous network in which a femto cell, together with a macro cell, is operated, if the femto cell is in the open access mode, a user can access a desired cell from among the macro cell and the femto cell and use data service.

If a femto cell is, for example, in the closed mode, a common user who uses a macro cell is unable to use the femto cell although it is subject to interference from a femto cell to which the macro cell sends a signal having strong intensity.

Macro eNBs are coupled through an X2 interface. The X2 interface maintains the operation of seamless handover and lossless handover between the eNBs and supports the management of radio resources. Accordingly, the X2 interface plays an important role in Inter-Cell Interference Coordination (ICIC) between the macro eNBs.

In contrast, an interface, such as X2, is not present between a macro eNB and the femto eNB 320. Accordingly, dynamic signaling is not performed between the macro eNB and the femto eNB 320.

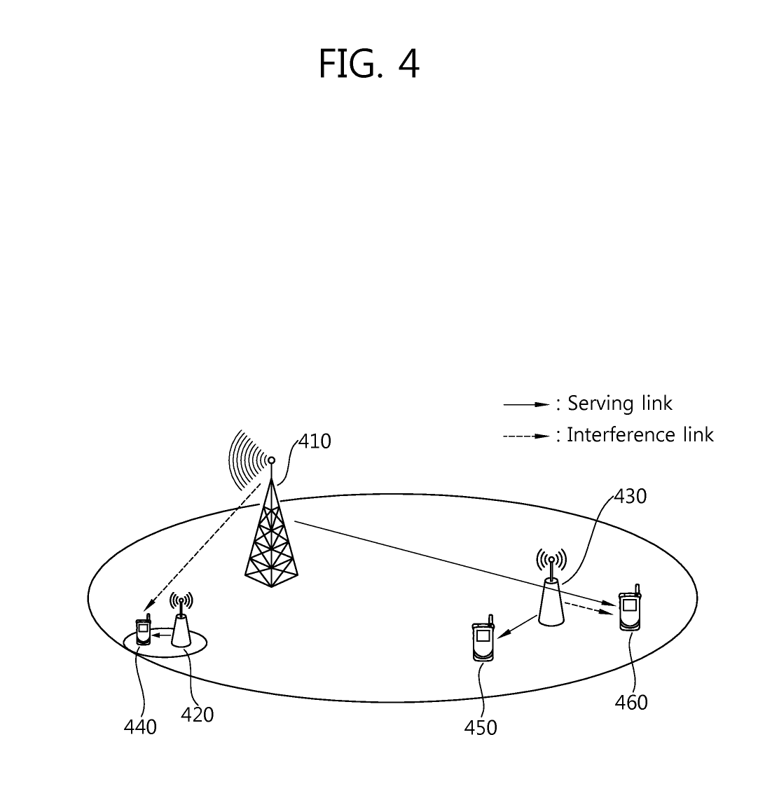

FIG. 4 schematically illustrates that UE is influenced by interference between a macro cell, a femto cell, and a pico cell in downlink.

Referring to FIG. 4, the UE 450 can access a femto eNB 430 and use a femto cell. However, if the femto eNB 430 is in a CSG mode and UE 460 near the femto eNB 430 is not registered user UE of a CSG, the UE 460 cannot access a femto cell having strong signal intensity, but can inevitably access a macro eNB 410 having relatively weaker signal intensity than that of the femto cell. Accordingly, in this case, the UE 460 can receive an interference signal from the femto cell.

Furthermore, the UE 440 can access a pico eNB 420 and use a pico cell. However, the UE 440 can be subject to interference due to the signal of the macro eNB 410.

As described above, regarding interference between heterogeneous cells, a victim cell that is greatly influenced by interference or that needs to be further protected from interference is a macro cell or a pico cell. In contrast, an aggressor cell that influences a victim cell through interference or that is less influenced by interference is a femto cell.

A method of reducing inter-cell interference includes Inter-Cell Interference Coordination (ICIC). In general, ICIC is a method of supporting reliable communication for a user who belongs to a victim cell when the user is placed near an aggressor cell. For ICIC, for example, a restriction can be imposed to a scheduler regarding the use of what time and/or frequency resources. Furthermore, a restriction regarding how much power will be used in specific time resources or specific frequency resources or both can also be imposed to a scheduler.

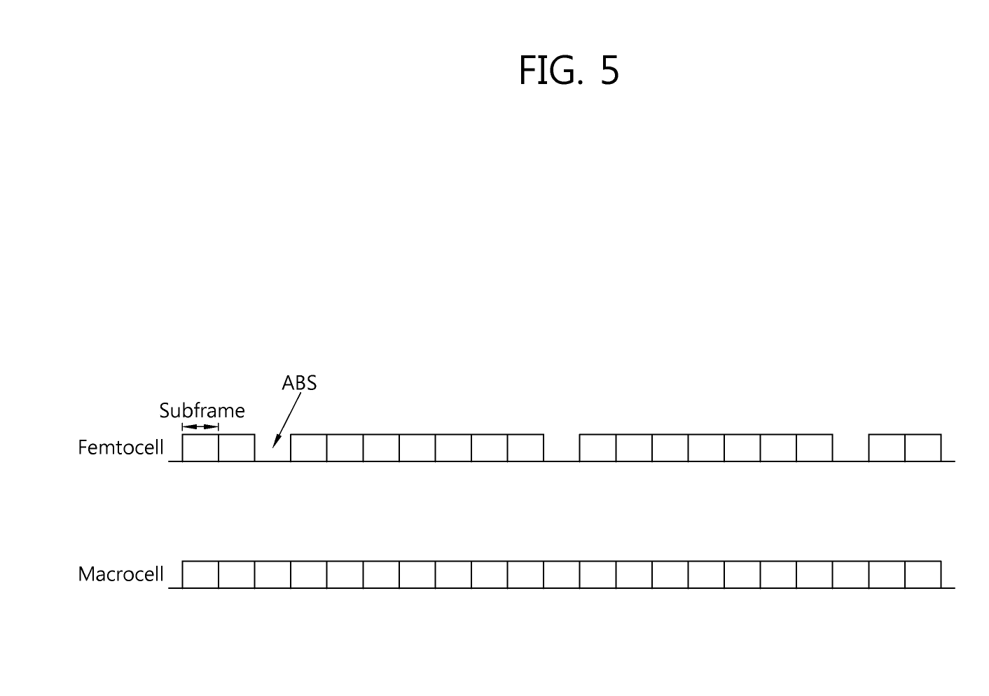

FIG. 5 is a diagram showing a frame pattern for ICIC in a heterogeneous network system in accordance with an example of the present invention.

Referring to FIG. 5, a frame pattern is configured so that interference is not generated between different types of cells (e.g., a macro cell and a femto cell). For example, the third subframe of the femto cell, transmission power is very low because the femto cell rarely sends a signal. In this case, this subframe is called an Almost Blank Subframe (ABS) because power for the signal transmitted in the subframe is set to almost 0 or to 0. In the ABS, interference that may be generated from the femto cell can be excluded. Accordingly, in the subframe configured as an ABS by the femto cell, the macro cell can provide service to UE within the macro cell without the influence of interference (i.e., interference-free). Here, the ABS is defined as a subframe in which transmission power, such as control information, data, and signaling transmitted through the subframe (e.g., signals transmitted for channel measurement and synchronization), is reduced or not transmitted. For backward compatibility, control information, data, signaling, and system information necessary for UE need to be transmitted. Furthermore, this pattern to which the ABS is applied is called an ABS pattern. The ABS pattern can be configured, for example, in a 40 ms unit. Alternatively, in order to coordinate interference, an ABS can have a specific pattern within a radio frame. This specific pattern is also called a frame pattern. If the frame pattern is used, interference can be coordinated because an ABS within a specific cyclic interval that includes a plurality of subframes is variably configured.

An ABS is an ICIC method based on Time Division Multiplexing (TDM) in which time resources, such as subframes, are divided and used by heterogeneous cells. Interference can be coordinated by variably configuring a frame pattern structure itself within a specific cyclic interval that includes a plurality of subframes.

FIG. 5 illustrates the frame pattern for ICIC between a macro cell and a femto cell, for convenience of description, but this is only an example. The frame pattern of FIG. 5 can be equally applied between a plurality of cells including an aggressor cell and a victim cell and between a plurality of cells having different coverages. For example, the frame pattern of FIG. 5 can be applied to a macro eNB and a pico eNB. In this case, in FIG. 5, the macro eNB can be replaced with a pico eNB, and the femto eNB can be replaced with a macro eNB.

A paging process is described below. The paging process is basically divided into a radio paging process and an MME paging process. In the radio paging process, an eNB performs the paging process on UE. The radio paging process is a process that is used for an eNB to send paging information to UE in an RRC idle state, inform UE in an RRC idle state or an RRC-connected state of a change of system information, notify a primary Earthquake and Tsunami Warning System (ETWS) or a secondary ETWS, or notify a Commercial Mobile Alert System (CMAS). The paging information is used for UE to establish RRC connection so that the UE can receive an incoming call.

The MME paging process is a process that is used for an MME to page UE that accesses an eNB. In the MME paging process, the MME sends paging configuration information, including a paging discontinuous reception (hereinafter referred to as ‘paging DRX’) value and a list of CSG IDs, to an eNB. The paging DRX value is a DRX cycle value specific to the UE, and the list of CSG IDs includes the CSG IDs. CSG cells not included in the list of CSG IDs do not send a paging message. When the paging configuration information is received, the eNB sends a paging message to the UE according to the radio paging process.

UE in an RRC idle state can perform a DRX operation in order to reduce power consumption that is generated when receiving data. The UE can receive a paging message and system information from an eNB during the time that has been agreed with the eNB, but may not receive any signal from the eNB for the remaining time. The eNB can control paging by configuring a paging occasion and DRX parameters, such as a paging frame, so that the UE can receive the paging message from among pieces of information transmitted by the eNB.

The Paging Occasion (PO) is a subframe transmitted through the paging message, and a Paging-Radio Network Temporary Identifier (P-RNTI) indicative of the paging message is scrambled into the PDCCH of the subframe. The Paging Frame (PF) is a radio frame which includes at least one PO. The radio frame can include 10 subframes. If UE operates in DRX, the UE monitors only one PO in each DRX cycle.

Interference between heterogeneous cells can also be likewise generated in a paging process between a macro cell and UE. If UE that does not have CSG memberships is placed in the coverage of a femto cell, a paging message from a macro cell can be influenced by interference generated due to a strong signal from the femto cell. Although a macro eNB and a femto eNB operate based on an ABS pattern, the interference with the paging message cannot be fully removed. This is because a different paging frame or paging occasion is set in UE if a DRX value and an IMSI value are different according to the UE, with the result that the location of a subframe in which paging is generated can be changed.

Accordingly, if interference between heterogeneous cells is present, a macro eNB needs to control a paging frame or a paging occasion in order to avoid the interference. First, a criterion regarding whether interference between heterogeneous cells is present or not can include, for example, whether or not a macro eNB detects a femto eNB. In this criterion, if the macro eNB detects the femto eNB, the macro eNB can determine that interference between heterogeneous cells is present. In contrast, if the femto eNB is not detected, the macro eNB can determine that interference between heterogeneous cells is not present.

In order to coordinate interference between heterogeneous cells, a macro eNB can control paging, and an OAM can change an ABS pattern so that a subframe configured as an ABS is further increased. If a subframe configured as an ABS is increased, the throughput of a femto eNB can be deteriorated. To control paging includes controlling the location of a radio frame or subframe in which paging is generated or controlling the frequency number of generated paging. If a macro eNB changes a parameter related to a paging frame or a paging occasion, the location of a frame or subframe in which paging is generated and the frequency number of generated paging can be controlled.

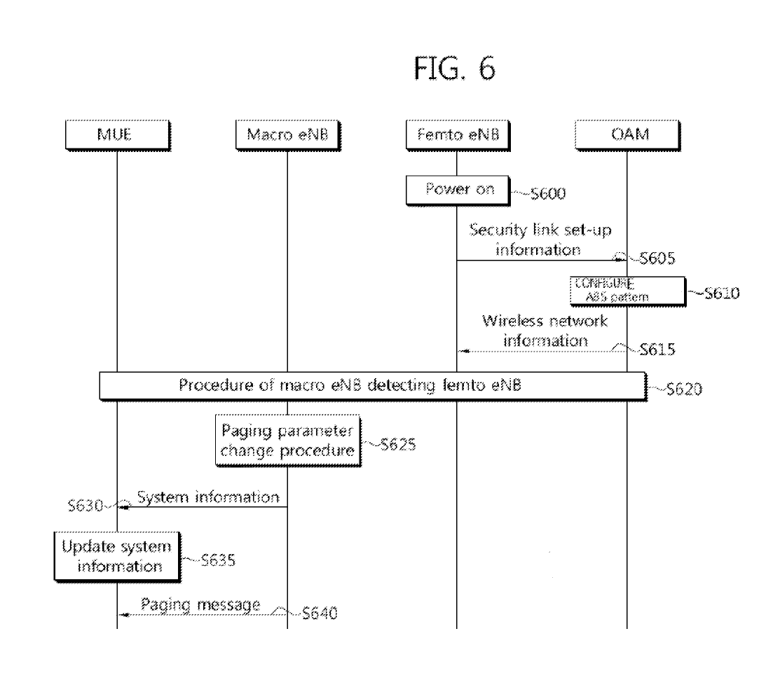

FIG. 6 is a flowchart illustrating a method of controlling paging in accordance with an example of the present invention. FIG. 6 illustrates a method of controlling paging between a macro eNB and a femto eNB, but this is only an example. That is, the method of controlling paging in FIG. 6 can be equally applied between a plurality of cells including an aggressor cell and a victim cell and between a plurality of cells having different coverages. For example, the method of controlling paging in FIG. 6 can also be applied to a macro eNB and a pico eNB. In this case, in FIG. 6, the macro eNB can be replaced with a pico eNB, and the femto eNB can be replaced with a macro eNB.

Referring to FIG. 6, MUE is in a state in which the MUE has been camped on a macro cell provided by a macro eNB. The MUE, the macro eNB, and a femto eNB can operate based on a frame structure based on TDD. The MUE may be in an RRC idle state. When the femto eNB is powered on at step S600, the femto eNB sends security link configuration information for establishing a security link with the OAM to the OAM at step S605. The security link is established based on information that is stored in memory when the product of the femto eNB is released.

The OAM configures the ABS pattern of the femto eNB based on the ABS patterns of eNBs (e.g., a macro eNB, a pico eNB, or a femto an eNBs having different memberships), including the coverage of the femto eNB, or eNBs (e.g., a macro eNB, a pico eNB, or a femto eNB having different memberships) adjacent to the femto eNB and information about whether or not the eNBs have been synchronized at step S610. Here, the ABS pattern may have been configured to have transmission power that is controlled in a subframe determined by taking the femto eNB into consideration.

The OAM sends radio network information for the femto eNB to the femto eNB at step S615. The radio network information includes at least one of the ABS pattern and radio configuration information. The radio configuration information includes a radio parameter for the present wireless environment regarding a macro eNB that includes the coverage of the femto eNB or a macro eNB adjacent to the femto eNB. Although not shown, the femto eNB measures the intensities of signals that are received from adjacent eNBs including the macro eNB based on the radio configuration information. Furthermore, the femto eNB determines the intensity of a transmitted signal based on the measured signal intensity. The femto eNB can control the amount of transmission power of each of a control channel, a data channel, a reference signal, and a synchronization signal that are included in a subframe configured as an ABS based on the measured signal intensity and an ABS pattern. Furthermore, the femto eNB maps a signal whose transmission power has been controlled to a predetermined subframe and sends the signal.

The macro eNB performs a detection process (i.e., femto cell detecting process) for detecting an aggressor cell that influences interference between heterogeneous cells at step S620. A process of the macro eNB detecting an aggressor cell, that is, a femto cell, may be various. For example, when the macro eNB receives a Physical Cell Identifier (PCI) or E-UTRAN Cell Global ID (E-CGI) of a specific femto cell or a measurement report message, informing whether or not a cell measured by the MUE is a femto cell by checking a CSG ID transmitted by the femto cell, from the MUE, the macro eNB can detect the specific femto cell. The process of detecting an aggressor cell can be based on an Automatic Neighbor Relation (hereinafter referred to as an ‘ANR’) process for minimizing or removing a manual task for information about adjacent eNBs when optimizing information about adjacent eNBs that are newly installed. An interface (e.g., X2 interface) through which pieces of information are exchanged between eNBs can be automatically established using the ANR procedure.

For another example, the macro eNB can detect a specific femto eNB by receiving the ABS pattern of the specific femto eNB. The ABS pattern is information that is provided from the OAM, maintaining and managing femto eNBs, to a femto eNB in order to coordinate interference between heterogeneous cells. The existence of an ABS pattern has the same meaning as the existence of a femto eNB. Accordingly, the macro eNB can detect a femto eNB based on whether an ABS pattern is present or not.

The macro eNB performs a process of changing a paging parameter at step S625. The paging parameter includes a default paging cycle ‘defaultPagingCycle’, a UE-specific paging cycle, and paging cycles T and nB.

The default paging cycle indicates a paging cycle that is set by default in a cell-specific way and can have any one of 32 Radio Frames (RFs), 64 radio frames, 128 radio frames, and 256 radio frames.

The UE-specific paging cycle is set in each UE. A value of the UE-specific paging cycle is transmitted to only corresponding UE through RRC signaling. Accordingly, the UE needs to operate in an RRC-connected state in order to receive UE-specific paging information.

A shorter one of a default paging cycle and a UE-specific paging cycle is determined as the paging cycle T. If the paging cycle T is not additionally configured in a higher layer (i.e., MME, RRC, or NAS), a default paging cycle is determined as the paging cycle T.

‘nB’ is a paging parameter represented by a value obtained by multiplying the paging cycle T by a constant. For example, any one of values 4T, 2T, T, T/2, T/4, T/8, T/16, and T/32 is selected as ‘nB’.

A paging frame and a paging occasion can be determined based on the paging parameters. More particularly, the paging frame is determined by three paging parameters: a DRX cycle, an IMSI value of UE, and a value of the paging parameter nB smaller than a value of the paging cycle T. Furthermore, the paging occasion is determined by only an IMSI value of UE when a value of the paging parameter nB is smaller than a value of the paging cycle T and is determined by both a value of the paging parameter nB and an IMSI value of UE when a value of the paging parameter nB is a value of the paging cycle T or higher.

A change of the paging parameters by the macro eNB can include changing a value of the paging parameter nB into a value equal to or less than a value of the paging cycle T, for example, when a value of the paging parameter nB is greater than a value of the paging cycle T, that is, a value of the paging parameter nB is set to 4T or 2T. When a value of the paging parameter nB is changed, a paging distribution within a DRX cycle to be monitored by UEs and a distribution of paging occasions within a radio frame are changed. This can be applied to all the cases where a default DRX cycle and a UE-specific DRX cycle are applied. The frequency number of paging can be controlled and interference between heterogeneous cells can be avoided by changing a paging parameter.

A cause to trigger a change of a paging parameter is as follows. For example, the paging parameter change procedure may be performed based on the ABS pattern of a femto eNB. For example, it is assumed that a subframe not configured as an ABS is the paging occasion of a macro eNB. Data or control signals that are exchanged between a femto eNB and FUE in a subframe can function as interference with a paging message that is transmitted from a macro eNB to the MUE. In this case, the macro eNB may artificially change a paging parameter so that the subframe does not become a paging occasion. Through this change, the interference with the paging message can be removed. If a subframe is excluded from a paging occasion instead of configuring the subframe as an ABS as described above, the throughput of the femto eNB can be maintained. Meanwhile, if the subframe configured as an ABS is the paging occasion of the macro eNB, the macro eNB may not change a paging parameter because interference is not generated.

For another example, the paging parameter change procedure can be performed even without an ABS pattern. That is, when a macro eNB detects the existence of a femto eNB, the macro eNB change a paging parameter irrespective of an ABS pattern. A change of a paging parameter includes a change of the paging parameter so that a paging occasion becomes a specific level or lower. For example, if a femto cell within a macro cell or in an area neighboring a macro cell is detected, a macro eNB prevents a value of the paging parameter nB from being set to a T value or higher.

The macro eNB sends system information, including the changed paging parameter, to the MUE at step S630. Table 1 shows an example of the system information including the changed paging parameter.

TABLE 1

PCCH-Config ::=SEQUENCE {defaultPagingCycle
(T value)ENUMERATED {rf32, rf64, rf128, rf256},
nBENUMERATED {fourT, twoT, oneT, halfT,
quarterT, oneEighthT, oneSixteenthT, oneThirtySecondT}}

Referring to Table 1, the system information including the changed paging parameter includes a changed default paging cycle or a changed paging parameter nB. The macro eNB can change a paging message or a system information validity value for informing whether or not system information has been changed in order to update the system information.

The MUE updates existing system information based on the system information received from the macro eNB at step S635. The macro eNB sends a paging message to the MUE based on the changed paging parameter at step S640. The MUE can receive the paging message from the macro eNB based on a paging parameter that has been changed based on the ABS pattern of the femto eNB. Accordingly, the paging message received by the MUE may not be influenced by interference or may be influenced by small interference that is generated due to a signal from the femto eNB.

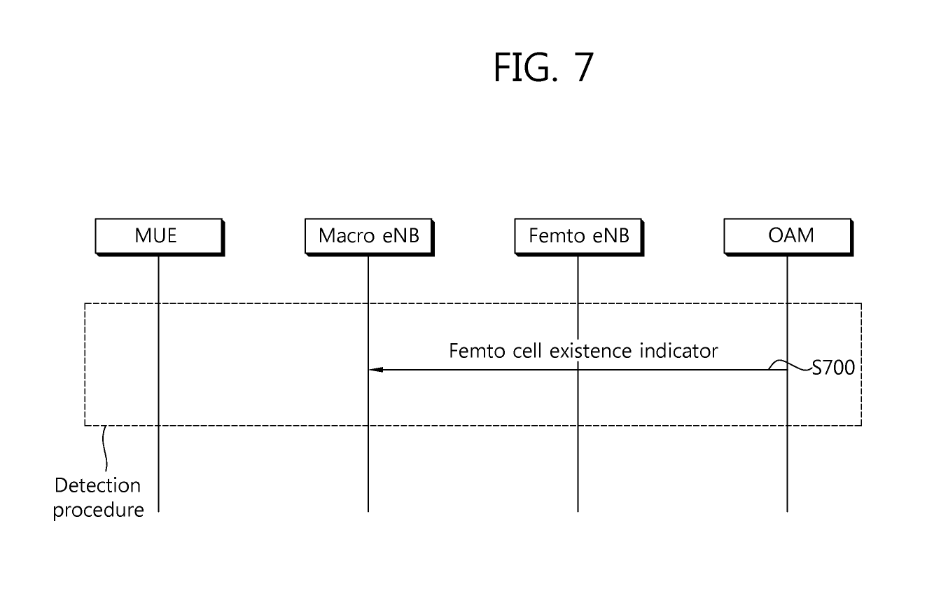

FIG. 7 is a flowchart illustrating a method of a macro eNB detecting a femto eNB in order to control paging in accordance with an example of the present invention. The method of FIG. 7 corresponds to step S620 of FIG. 6, that is, the detection process.

Referring to FIG. 7, the detection process includes sending, by an OAM, a femto cell existence indicator to the macro eNB at step S700. A target to which the femto cell existence indicator is transmitted by the OAM can include eNBs adjacent to the femto eNB (e.g., a macro eNB, a pico eNB, or a femto eNB having different memberships) or other eNBs having a coverage including a femto cell coverage (e.g., a macro eNB, a pico eNB, or a femto eNB having different memberships).

The femto cell existence indicator is information indicating that a femto cell managed by the OAM is present. The femto cell existence indicator can be an ABS pattern. The OAM can inform the macro eNB of the existence of a femto cell by sending the ABS pattern to the macro eNB in addition to the femto eNB. Alternatively, the femto cell existence indicator may be indication information indicating whether or not a femto cell is present by 1 bit. For example, when the femto cell existence indicator is 1, it may indicate that a femto cell is present. When the femto cell existence indicator is 0, it may indicate that a femto cell is not present.

When receiving the femto cell existence indicator from the OAM, the macro eNB can detect the femto eNB. Accordingly, in FIG. 6, the processes following step S625 can be performed.

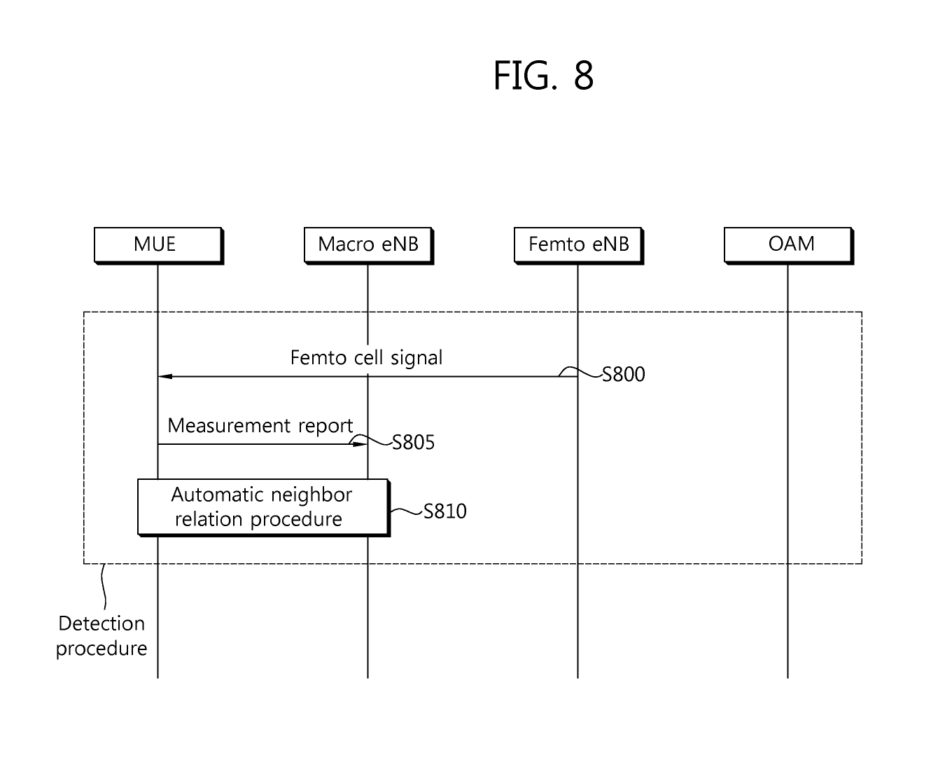

FIG. 8 is a flowchart illustrating a method of a macro eNB detecting a femto eNB in order to control paging in accordance with another example of the present invention. The method of FIG. 8 corresponds to step S620 of FIG. 6, that is, the detection process.

Referring to FIG. 8, the femto eNB sends a femto cell signal to MUE at step S800. Here the MUE is connected to the macro eNB not the femto eNB, but the MUE can be included in the coverage of the femto eNB and can receive a signal from the femto eNB. The femto cell signal can be a broadcast channel (BCCH) on a femto cell. Alternatively, the femto cell signal may be a synchronization signal including the PCID of a femto cell.

The MUE receives the femto cell signal, measures the received femto cell signal, and sends a measurement report to the macro eNB at step S805. Here, the MUE may be in an RRC-connected state. The measurement report may be triggered when an event occurs or may be triggered periodically. The measurement report triggered by the MUE may include a neighbor cell list and a PCID. Here, the neighbor cell list includes a femto cell. A criterion on which the MUE measures the intensity of a femto cell signal can be Reference Signal Received Power (RSRP) and Reference Signal Received Quality (RSRQ). RSRP and RSRQ can be defined as follows. RSRP is calculated as a linear average to the power contribution of resource elements. Here, the resource elements carry a cell-specific reference signal within a measurement frequency bandwidth that is taken into consideration. A reference point for RSRP is the antenna connector of MUE. Meanwhile, RSRQ is defined as a ratio of RSRP and a Received Signal Strength Indicator (RSSI) as in Equation 2.

RSRQ=N X(RSRP/RSSI) [Equation 2]

In Equation 2, N is the number of resource elements of the carrier RSSI measurement bandwidth of a wireless access network. In Equation 2, the measurement of a numerator and a denominator is performed by a set of the same resource blocks. RSSI includes a linear average of the entire reception power. The entire reception power is monitored only within an OFDM symbol which includes reference symbols within a measurement bandwidth and is a value obtained over N resource blocks. The reference symbols can be OFDM symbols including a Cell-specific Reference Signal (CRS). Alternatively, the reference symbols may be all the OFDM symbols within a subframe.

After checking that Neighbor Registration (NR) has not been performed based on the PCID of the femto eNB, the macro eNB, together with the MUE, performs an ANR procedure at step S810. The ANR procedure is a procedure that is used for the macro eNB to minimize or remove a manual task for information about adjacent eNBs including a femto eNB when optimizing the information about the adjacent eNBs.

The macro eNB can detect the femto eNB based on the ANR procedure. Accordingly, in FIG. 6, the processes following step S625 can be performed.

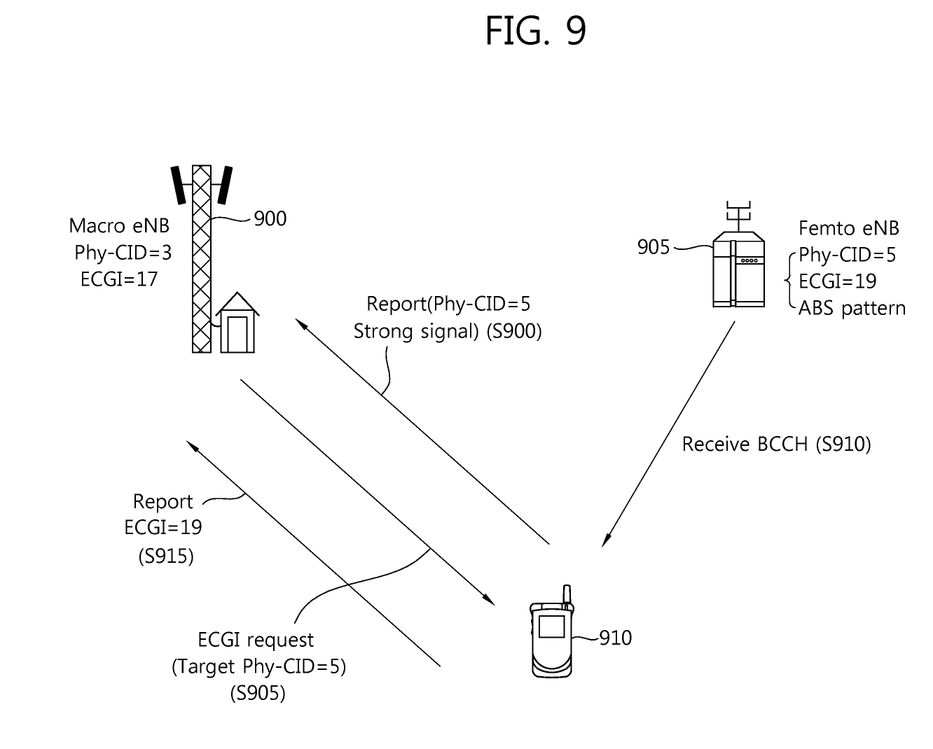

FIG. 9 is an explanatory diagram illustrating an ANR procedure in accordance with an example of the present invention. The ANR procedure of FIG. 8 corresponds to step S810 of FIG. 8.

Referring to FIG. 9, a heterogeneous network system includes a macro eNB 900, a femto eNB 905, and UE 910. Information about the PCID (PCID) of the macro eNB 900 is 3, and a value of an E-UTRAN Cell Global ID (ECGI) thereof is 17. Information about the PCID of the femto eNB 905 is 5 and a value of an ECGI thereof is 19, and the femto eNB 905 operates based on specific ABS pattern information. The UE 910 has a function or capabilities for detecting that the femto eNB 905 enters the network while communicating with the macro eNB 900. The UE 910 receives a measurement report request from the macro eNB 900 that has been accessed after RRC connection was established and reports information about all the PCIDs to the macro eNB 900 in response to the measurement report request while the UE 10 is in an RRC connection mode.

First, the UE 910 sends information about the PCID of the femto eNB 905, measured by the UE 910, to the macro eNB 900 according to a common measurement process at step S900.

If the information about the PCID received from the UE 910 is not searched for in the adjacent cell database of a serving eNB because it has not been registered with the adjacent cell database, the ANR function of the macro eNB 900 requests the UE 910 to search for the ECGI of the femto eNB 905 based on the information about the PCID that identifies the femto eNB 905 at step S905. Here, the macro eNB 900 sets the information about the PCID of the femto eNB 905 to 5 and sends the set information. Thus, the UE 910 can specify that an ECGI value to be transmitted to the macro cell 900 is related to what neighbor cell.

Thereafter, the UE 910 reads a BCCH broadcasted by the femto eNB 905 at step S910. The BCCH includes SIB1 including information about the PCID and ECGI values of the femto eNB 905.

The UE 910 sends an ECGI value of the femto eNB 905 in which information about the PCID is 5 to the macro eNB 900. If the femto eNB 905 is a CSG cell or a mixed cell, the UE 910 sends a CSG ID to the macro eNB 900 along with the ECGI value.

The macro eNB 900 adds the femto eNB 905 to NRT. The macro eNB 900 may configure a new interface, for example, an X2 interface, if necessary.

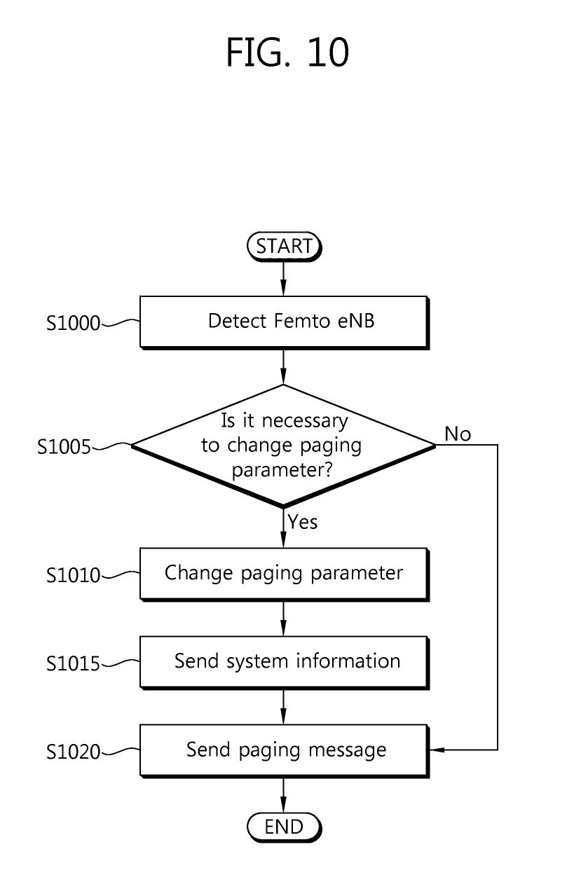

FIG. 10 is a flowchart illustrating a method of a macro eNB controlling paging in accordance with an example of the present invention.

Referring to FIG. 10, the macro eNB detects a femto eNB at step S1000. A process of the macro eNB detecting the femto eNB can be various. For example, when receiving the PCID of a specific femto eNB from UE, the macro eNB can detect the specific femto eNB. In this case, the ANR procedure for minimizing or removing a manual task for information about an adjacent eNB when optimizing the information about the newly installed adjacent eNB can be used. An interface (e.g., X2 interface) through which pieces of information are exchanged between eNBs can be automatically established using the ANR procedure.

For another example, the macro eNB can detect a specific femto eNB by receiving the ABS pattern of the specific femto eNB. The ABS pattern is information provided from an OAM for maintaining and managing femto eNBs to the femto eNB in order to coordinate interference between heterogeneous cells. The existence of the ABS pattern can reveal the existence of the femto eNB. Accordingly, the macro eNB can detect the femto eNB based on whether the ABS pattern is present or not.

The macro eNB determines whether or not a change of a paging parameter is necessary at step S1005. For example, a requisite that a paging parameter is changed can include that the macro eNB detects the femto eNB and a value of nB is greater than a value of T. If the macro eNB detects a femto eNB and a value of nB is greater than a value of T, the macro eNB determines that a paging parameter needs to be changed. In contrast, if a value of nB is smaller than a value of T, the macro eNB determines that a change of a paging parameter is not necessary.

If, as a result of the determination, it is determined that a change of a paging parameter is necessary, the macro eNB changes the paging parameter at step S1010. The changed paging parameter can be nB.

The macro eNB sends system information, including a changed paging parameter, such as that of Table 1, to the UE at step S1015. The system information includes a changed default paging cycle or a changed nB. The macro eNB can change a paging message or system information validity value for informing whether or not the system information has been changed in order to update the system information.

the macro eNB sends the paging message to the UE based on the changed paging parameter at step S1020. When the paging parameter is changed, a paging frame or a paging occasion or both can be changed.

The paging frame and the paging occasion are determined based on DRX parameters received through system information about a cell on which the UE has camped. First, Equation 3 is an example of a method of determining the paging frame.

$$SFN mod T = \frac{T}{N} \times ( UE ID mod N ) \qquad [ Equation 3 ]$$

Referring to Equation 3, SFN is a radio frame number and can be defined to have 0 to 1023 or 1 to 1024. T is a paging cycle, and N=MIN(T, nB). That is, N is defined as the smallest value of a value of T and a value of nB. UE ID is defined as in Equation 4.

UE ID=IMSI mod 1024 [Equation 4]

In Equation 4, if UE does not have an IMSI value, a value of the UE ID is set to 0. Equation 5 is an example of a method of determining the paging occasion.

$$i\_s = ⌊ \frac{UE ID}{N} ⌋ mod Ns \qquad [ Equation 5 ]$$

Referring to Equation 5, i_s indicates the paging occasion of a subframe pattern defined in Tables 2 and 3 below, and Ns=MAX(1, nB/T). That is, Ns is a greater value of values of nB and T. Accordingly, Ns=1 when nB/T<1, and Ns=nB/T when nB/T≧1. Table 2 is applied to an FDD system, and Table 3 is applied to a TDD system.

TABLE 2

| | PO | PO | | PO |
|---|---|---|---|---|
| Ns | when i_s = 0 | when i_s = 1 | PO when i_s = 2 | when i_s = 3 |
| 1 | 9 | N/A | N/A | N/A |
| 2 | 4 | 9 | N/A | N/A |
| 4 | 0 | 4 | 5 | 9 |

TABLE 3

| | PO | PO | | PO |
|---|---|---|---|---|
| Ns | when i_s = 0 | when i_s = 1 | PO when i_s = 2 | when i_s = 3 |
| 1 | 0 | N/A | N/A | N/A |
| 2 | 0 | 5 | N/A | N/A |
| 4 | 0 | 1 | 5 | 6 |

Referring to Tables 2 and 3, when Ns=1, a Paging Occasion (PO) is present only in one subframe. For example, a No. 9 subframe becomes a PO in the case of an FDD system, and a No. 0 subframe becomes a PO in the case of a TDD system. Meanwhile, when Ns=2, Nos. 4 and 9 subframes become POs in the case of an FDD system, and Nos. 0 and 5 subframes become POs in the case of a TDD system.

For example, it is assumed that nB=2T, T=64, and an IMSI value (decimal number)=5632 before a macro eNB detects a femto eNB. A paging frame is calculated as follows. In accordance with Equations 3 and 4, a paging frame is (64/128)*((5632 mod 1024))mod 64)=0. Accordingly, the paging frame has an SFN value 0, 64, 128, 192, . . .

Meanwhile, a PO is calculated as follows based on a TDD system. In accordance with Equation 5, Ns=2, and i_s=0. When UE performs a DRX operation, Nos. 0 and 5 subframes becomes POs in each of the paging frames 0, 64, 128, 192, . . .

However, the macro eNB performs a paging parameter change procedure because the macro eNB detects a femto eNB and nB>T. That is, a value of nB is changed from 2T to a value equal to or smaller than a value of T, for example, T/2. A paging frame and a PO according to the changed paging parameter are calculated as follows. First, as in before the change, the paging frame has an SFN value of 0, 64, 128, 192, . . . , because (64/32)*((5632 mod 1024)) mod 32)=0. Meanwhile, only the No. 0 subframe becomes a PO in each of the paging frames 0, 64, 128, 192, . . . , when a DRX operation is performed because the PO is Ns=1 and i_s=0. That is, as a result of check before and after the paging parameter is changed, in the PO, the Nos. 0 and 5 subframes are reduced to the No. 0 subframe. Accordingly, the throughput of a femto cell can be improved and reliability in the transmission of a paging message can be improved because the No. 5 subframe does not need to be set as an ABS in order to coordinate interference between heterogeneous cells.

Referring back to step S1005, if, as a result of the determination, it is determined that a change of the paging parameter is not necessary, the macro eNB sends a paging message based on an existing paging parameter at step S1020.

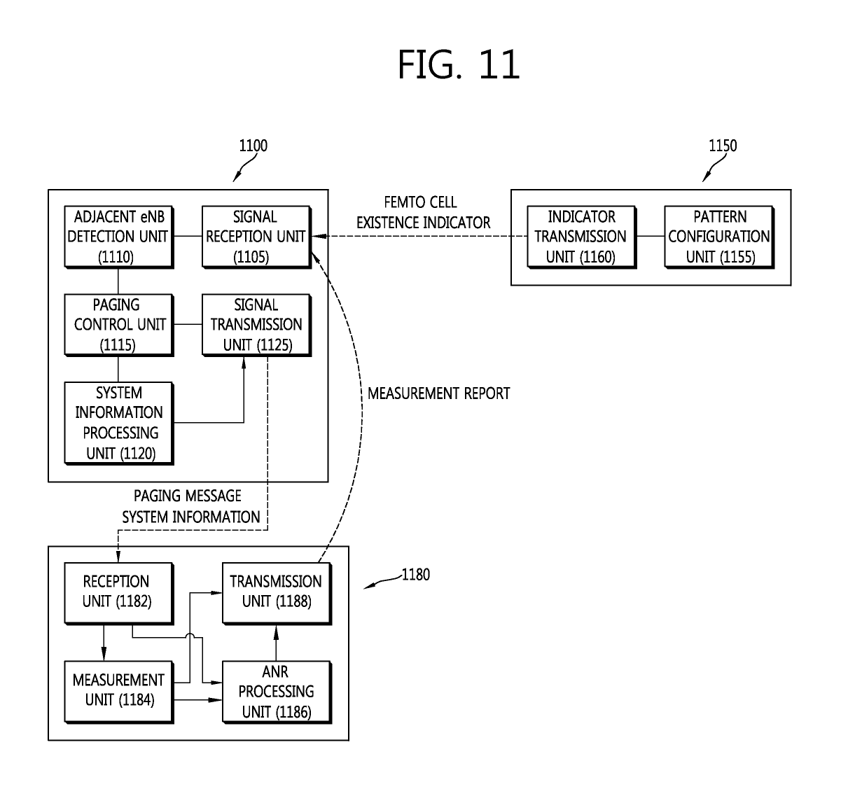

FIG. 11 is a block diagram of a macro eNB, UE, and an Operation And Management (OAM) in accordance with an example of the present invention.

Referring to FIG. 11, the macro eNB 1100 includes a signal reception unit 1105, an adjacent eNB detection unit 1110, a paging control unit 1115, a system information processing unit 1120, and a signal transmission unit 1125.

The signal reception unit 1105 receives a measurement report from UE 1180 or receives a femto cell existence indicator from the OAM 1150 and transfers the measurement report or the femto cell existence indicator to the adjacent eNB detection unit 1110. The measurement report is a message of an RRC layer level, and the measurement report includes information about the intensity of a signal from a femto cell that has been measured by the UE 1180. The femto cell existence indicator is information indicating that a femto cell managed by the OAM 1150 is present. The femto cell existence indicator can be an ABS pattern. When the OAM 1150 sends the ABS pattern to a macro eNB in addition to a femto eNB, the macro eNB can be informed of the existence of the femto cell. Alternatively, the femto cell existence indicator may be indication information indicating whether a femto cell is present or not by 1 bit. For example, it may indicate that a femto cell is present when the femto cell existence indicator is 1, and it may indicate that a femto cell is not present when the femto cell existence indicator is 0.

The adjacent eNB detection unit 1110 detects whether or not an aggressor cell that influences interference between heterogeneous cells, that is, a cell that is adjacent to the macro eNB 1100 or included in the coverage of the macro eNB 1100, is present based on the measurement report or the femto cell existence indicator. For example, if it is determined that the measurement report is a specific level or higher, the adjacent eNB detection unit 1110 can detect an adjacent eNB. Alternatively, if an ABS pattern is detected from the femto cell existence indicator, the adjacent eNB detection unit 1110 can detect the existence of a femto eNB nearby.

When the aggressor cell is detected, the paging control unit 1115 determines whether or not a currently set paging parameter needs to be changed, that is, whether or not a currently set paging frame or paging occasion needs to be changed. If, as a result of the determination, it is determined that the paging parameter needs to be changed, the paging control unit 1115 changes the paging parameter. For example, the changed paging parameter can be ‘nB’. The paging control unit 1115 can change the paging frame or the paging occasion by controlling a value of nB as described above with reference to FIG. 10. The paging control unit 1115 generates a paging message based on the changed paging frame or the changed paging occasion or both and sends the paging message to the signal transmission unit 1125.

The system information processing unit 1120 generates system information including the changed paging parameter and transfers the system information to the signal transmission unit 1125.

The signal transmission unit 1125 sends the system information, including the changed paging parameter, and the paging message based on the changed paging parameter to the UE 1180.

The OAM 1150 includes a pattern configuration unit 1155 and an indicator transmission unit 1160.

The pattern configuration unit 1155 configures the ABS pattern of a femto eNB based on the ABS patterns of eNBs (e.g., a macro eNB, a pico eNB, or a femto an eNBs having different memberships), including the coverage of the femto eNB, or eNBs (e.g., a macro eNB, a pico eNB, or a femto eNB having different memberships) adjacent to the femto eNB and information about whether or not the eNBs have been synchronized. In particular, if an ABS pattern for 40 ms is to be configured, at least one N (i.e., an integer, wherein 1≦N≦4) is set for an ABS configuration for a No. 9 subframe.

The indicator transmission unit 1160 sends a femto cell existence indicator, including the ABS pattern, to the macro eNB 1100.

The UE 1180 includes a reception unit 1182, a measurement unit 1184, an ANR processing unit 1186, and a transmission unit 1188.

The reception unit 1182 receives system information including a changed paging parameter and a paging message based on the changed paging parameter from the macro eNB 1100. Alternatively, the reception unit 1182 may receive a PCID to identify a femto eNB. Furthermore, the reception unit 1182 receives a signal from a femto eNB, and the measurement unit 1184 measures the signal received from the femto eNB. Furthermore, the transmission unit 1188 sends a measurement report to the macro eNB 1100. Here, the UE 1180 may be in an RRC-connected state. The measurement report may be triggered when an event occurs or may be periodically triggered. The measurement report transmitted by the transmission unit 1188 can include a neighbor cell list and a PCID. Here, the neighbor cell list includes a femto cell. A criterion on which the measurement unit 1184 measures the intensity of a signal from a femto eNB can include RSRP and RSRQ.

The ANR processing unit 1186 receives a request that the ECGI of a femto eNB be searched for from the macro eNB 1100 based on information about a PCID to identify the femto eNB. Here, the macro eNB 1100 sets information about the PCID of the femto eNB as a value of the femto eNB and sends the set information. Thus, the ANR processing unit 1186 can specify that an ECGI value to be transmitted to the macro eNB 1100 is related to what neighbor cell.

The reception unit 1182 receives a request message that requests information about the femto eNB from the macro eNB 1100. Furthermore, the reception unit 1182 receives a BCCH broadcasted by the femto eNB in order to obtain the information about the femto eNB. The BCCH includes SIB1 including information about the PCID and ECGI value of the femto eNB. The ANR processing unit 1186 generates the ECGI value of the femto eNB, and the transmission unit 1188 sends the ECGI value to the macro eNB 1100. If the femto eNB is a CSG cell or a mixed cell, the ANR processing unit 1186 generates a CSG ID in addition to the ECGI value of the femto eNB, and the transmission unit 1188 sends the ECGI value and CSG ID of the femto eNB to the macro eNB 1100.

The macro eNB 1100 receives the ECGI value of the femto eNB, changes a paging parameter, such as a paging occasion or a paging frame or both, in order to prevent interference attributable to a signal from the femto eNB with reference to the ABS pattern of the femto eNB, and sends a paging message to the UE 1180 based on the changed paging parameter. The reception unit 1182 can receive the paging message based on the paging parameter that has been changed by the ABS pattern configured to have controlled transmission power in a subframe determined by taking the femto eNB into consideration. In other words, the reception unit 1182 can receive the paging message from which influence attributable to a signal transmitted by the femto eNB has been excluded or in which the influence of interference attributable to the signal is rarely present from the macro eNB 1100.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

The above embodiments include various aspects of examples. Although all possible combinations for representing the various aspects may not be described, those skilled in the art will appreciate that other combinations are possible. Accordingly, the present invention should be construed as including all other replacements, modifications, and changes which fall within the scope of the claims.

1. A macro evolved-NodeB (eNB1 for controlling paging in a wireless network system supporting heterogeneous cells, the macro eNB comprising:
a signal reception unit for receiving an Almost Blank Subframe (ABS) pattern, configured to have controlled transmission power in a subframe determined by taking an aggressor cell that generates interference between the heterogeneous cells into consideration, from an Operation and Management (OAM) for maintaining and managing the aggressor cell;
an adjacent eNB detection unit for detecting the aggressor cell based on the ABS pattern;
a paging control unit for, when detecting the aggressor cell, changing a paging parameter for User Equipment (UE) so that interference with the aggressor cell is avoided based on the ABS pattern, configuring a paging occasion indicative of a subframe on which a paging message is transmitted or a paging frame that is a radio frame comprising the at least one paging occasion based on the changed paging parameter, and generating the paging message for paging the UE; and
a signal transmission unit for sending system information comprising the changed paging parameter to the UE and sending the paging message to the UE in the paging frame or the paging occasion.

2. The macro eNB of claim 1, wherein the aggressor cell comprises a femto cell included in a cell coverage of the macro eNB.

3. The macro eNB of claim 1, wherein the paging control unit changes the paging parameter so that the paging occasion is reduced.

4. The macro eNB of claim 1, wherein the signal reception unit receives an E-UTRAN Cell Global ID (ECGI) regarding the aggressor cell from the UE.

5. The macro eNB of claim 1, wherein:
the signal reception unit receives a Physical Cell IDentifier (PCID) regarding the aggressor cell from the UE, and
the adjacent eNB detection unit detects the aggressor cell based on the PCID.

6. The macro eNB of claim 1, wherein:
the paging parameter comprises a default paging cycle, a UE-specific paging cycle, and paging cycles T and nB, and
the default paging cycle is set by default in a cell-specific way, the UE-specific paging cycle is set in a UE-specific way, a shorter paging cycle of the default paging cycle and the UE-specific paging cycle is determined as the paging cycle T, and the nB is a value obtained by multiplying the paging cycle T by a constant.

7. The macro eNB of claim 6, wherein the paging control unit configures the paging frame based on a discontinuous reception (DRX) cycle of the UE, an International Mobile Subscriber Identity (IMSI) of the UE, and a value of the nB smaller than a value of the T.

8. A method of a macro evolved-NodeB (eNB1 controlling paging in a wireless network system supporting heterogeneous cells, the method comprising:
receiving an Almost Blank Subframe (ABS) pattern, configured to have controlled transmission power in a subframe determined by taking an aggressor cell that generates interference between the heterogeneous cells into consideration, from an Operation and Management (OAM) for maintaining and managing the aggressor cell;
detecting the aggressor cell based on the ABS pattern;
changing a paging parameter for User Equipment (UE) so that interference with the aggressor cell is avoided based on the ABS pattern when detecting the aggressor cell;
configuring a paging occasion indicative of a subframe on which a paging message is transmitted or a paging frame that is a radio frame comprising the at least one paging occasion based on the changed paging parameter;
sending system information comprising the changed paging parameter to the UE; and
sending the paging message for paging the UE to the UE in the paging frame or the paging occasion.

9. The method of claim 8, wherein the aggressor cell comprises a femto cell included in a cell coverage of the macro eNB.

10. The method of claim 8, wherein the paging parameter is changed so that the paging occasion is reduced.

11. The method of claim 8, further comprising receiving an E-UTRAN Cell Global ID (ECGI) regarding the aggressor cell from the UE.

12. The method of claim 8, further comprising receiving a Physical Cell IDentifier (PCID) regarding the aggressor cell from the UE, wherein the aggressor cell is detected based on the PCID.

13. The method of claim 8, wherein:
the paging parameter comprises a default paging cycle, a UE-specific paging cycle, and paging cycles T and nB, and
the default paging cycle is set by default in a cell-specific way, the UE-specific paging cycle is set in a UE-specific way, a shorter paging cycle of the default paging cycle and the UE-specific paging cycle is determined as the paging cycle T, and the nB is a value obtained by multiplying the paging cycle T by a constant.

14. The method of claim 13, wherein the paging frame is configured based on a discontinuous reception (DRX) cycle of the UE, an International Mobile Subscriber Identity (IMSI) of the UE, and a value of the nB smaller than a value of the T.

15. User Equipment (UE) for receiving a paging message in a wireless network system supporting heterogeneous cells, the UE comprising:
a measurement unit for measuring a signal of a femto evolved-NodeB (eNB) that generates interference with the paging message of a macro eNB and generating a measurement report;
a transmission unit for sending the measurement report to the macro eNB;
a reception unit for receiving a request message, requesting information about the femto eNB, from the macro eNB and receiving a broadcast control channel (BCCH), comprising information about a Physical Cell IDentifier (PCID) identifying the femto eNB and an E-UTRAN Cell Global ID (ECGI) regarding the femto eNB, from the femto eNB; and
an Automatic Neighbor Relation (ANR) processing unit for specifying the information about the PCID and the ECGI,
wherein the transmission unit sends the information about the PCID and the ECGI to the macro eNB, and
the reception unit receives the paging message based on a paging parameter changed by an Almost Blank Subframe (ABS) pattern configured to have controlled transmission power in a subframe determined by taking the femto eNB into consideration.

16. The UE of claim 15, wherein:
the reception unit receives the BCCH, further comprising a Closed Subscriber Group (CSG) ID regarding the femto eNB, from the femto eNB, and
the transmission unit sends the CSG ID regarding the femto eNB to the macro eNB.

17. The UE of claim 15, wherein the reception unit receives the paging message based on the paging parameter changed so that a paging occasion indicative of a subframe on which the paging message is transmitted is reduced.

18. The UE of claim 15, wherein:
the changed paging parameter comprises a default paging cycle, a UE-specific paging cycle, and paging cycles T and nB, and
the default paging cycle is set by default in a cell-specific way, the UE-specific paging cycle is set in a UE-specific way, a shorter paging cycle of the default paging cycle and the UE-specific paging cycle is determined as the paging cycle T, and the nB is a value obtained by multiplying the paging cycle T by a constant.

19. A method of User Equipment (UE) receiving a paging message in a wireless network system supporting heterogeneous cells, the method comprising:
measuring a signal of a femto evolved-NodeB (eNB) that generates interference with the paging message of a macro eNB;
sending a measurement report indicative of the measurement to the macro eNB;
receiving a request message, requesting information about the femto eNB, from the macro eNB;
receiving a broadcast control channel (BCCH), comprising information about a Physical Cell IDentifier (PCID) identifying the femto eNB and an E-UTRAN Cell Global ID (ECGI) regarding the femto eNB, from the femto eNB; and
specifying the information about the PCID and the ECGI;
sending the specified information about the PCID and the specified ECGI to the macro eNB, and
receiving the paging message based on a paging parameter changed by an Almost Blank Subframe (ABS) pattern configured to have controlled transmission power in a subframe determined by taking the femto eNB into consideration.

20. The method of claim 19, wherein:
the BCCH further comprises a Closed Subscriber Group (CSG) ID regarding the femto eNB, and
the method further comprises sending the CSG ID regarding the femto eNB to the macro eNB.

21. The method of claim 19, wherein the changed paging parameter is changed so that a paging occasion indicative of a subframe on which the paging message is transmitted is reduced.

22. The method of claim 19, wherein:
the changed paging parameter comprises a default paging cycle, a UE-specific paging cycle, and paging cycles T and nB, and
the default paging cycle is set by default in a cell-specific way, the UE-specific paging cycle is set in a UE-specific way, a shorter paging cycle of the default paging cycle and the UE-specific paging cycle is determined as the paging cycle T, and the nB is a value obtained by multiplying the paging cycle T by a constant.
